(19) United States
(12) Patent Application Publication
(10) Pub. No.: US 2008/0171625 A1
(43) Pub. Date: Jul. 17, 2008

(54) Power-Split Transmission for a Hybrid Vehicle

(75) Inventors: Stefan Goldschmidt, Waiblingen (DE); Anna Krolo, Stuttgart (DE); Reiner Patzold, Stuttgart (DE); Jan-Peter Ziegele, Stuttgart (DE)

Correspondence Address: COLLARD & ROE, P.C., 1077 NORTHERN BOULEVARD, ROSLYN, NY, 11576, US

(73) Assignee: DAIMLERCHRYSLER AG, Stuttgart (DE)

(21) Appl. No.: 11/661,636

(22) PCT Filed: Aug. 24, 2005
(86) PCT No.: PCT/EP05/09108

§ 371 Date: May 11, 2007

(30) Foreign Application Priority Data
Aug. 31, 2004 (DE) 10 2004 042 007.6

(51) Int. Cl. B60K 6/20

(52) U.S. Cl. 475/5

(57) ABSTRACT

The invention relates to power-split transmission for a hybrid vehicle having an internal combustion engine, wherein the transmission has two electric motors (E1, E2) and a plurality of planetary gearings (N1, N2, N3, N4), and wherein for starting in a first driving range, a single power-split structure is provided at the input side, which structure is adjoined in a further driving range by a double power split. A further single power split for an overdrive adjoins these in a final driving range.

The invention relates to a power-split transmission for a hybrid vehicle having an internal combustion engine.

A power-split transmission for a hybrid vehicle having an internal combustion engine is already known from U.S. Pat. No. 6,478,705 B1.

It is an object of the invention to produce a drivetrain for a hybrid vehicle whose internal combustion engine is adjoined by a transmission with large transmission spread.

Said object is achieved according to the invention by means of the features of patent claim 1.

In the following, the single power split is shortened to SPS and the double power split is shortened to DPS.

In the following, a planetary gearing is also referred to as a differential. Here, a differential of said type has at least three transmission members which are preferably embodied as transmission shafts. Said three transmission shafts can in particular be
two input shafts and one output shaft or
one input shaft and two output shafts.

Patent claim 2 presents an embodiment of the invention in which the transmission spread is particularly large.

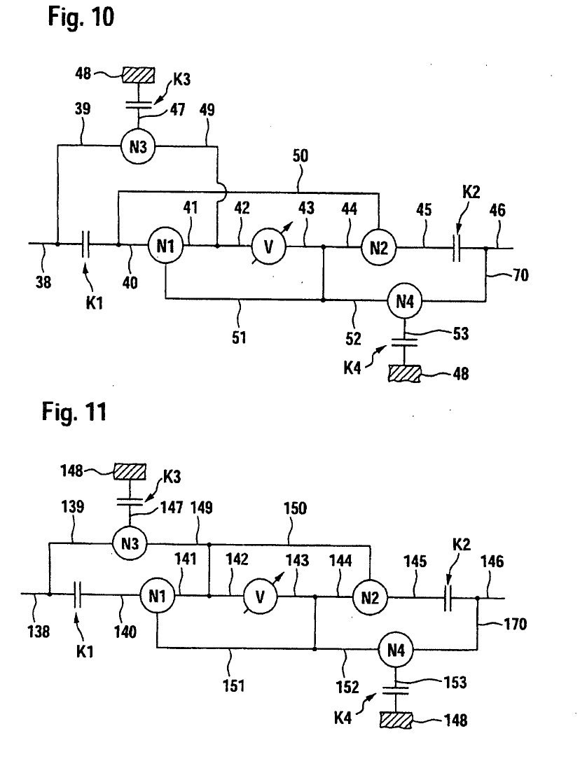

Patent claims 9 to 12 present particularly advantageous design embodiments which are illustrated in FIG. 10 to FIG. 13.

The drivetrain according to the invention for a hybrid vehicle has two electric motors, by means of which the transmission ratio for the driving internal combustion engine is varied in a continuous manner.

The two electric motors are integrated into the transmission in such a way that, at certain operating points, some of the power supplied by the internal combustion engine is conducted via the electric motors, and the remaining power flows via a mechanical path to the wheel. Here, the electric machines are operated either as motors or as generators. At said operating points, one electric motor introduces power into the drivetrain, while the other electric motor draws power from the drivetrain. Here, the two electric motors can be particularly advantageously controlled in such a way as to preserve the battery, by virtue of one electric motor consuming exactly the same amount of power as the other electric motor produces, so that the battery is utilized as a buffer to only a small extent. The battery can therefore be designed to have a capacity which is relatively low for electric drives, having a positive effect in particular with regard to weight, installation space and costs.

According to the invention, serial, parallel and power-split operation of the transmission is possible. Parallel operation means that the electric motors are coupled to the internal combustion engine in a rotationally fixed manner or via gearwheels. Serial operation means that power is transmitted exclusively electrically in the power flow of the drive power. Power-split transmission means that the power runs via at least two power paths, with at least one path transmitting electrical power and at least one path transmitting mechanical power.

The electric motors can assist the internal combustion engine for a so-called boost mode. A pure generator mode is also particularly advantageously possible when traveling downhill or during braking.

It is particularly advantageously possible for a reduction transmission, by means of which the rotational speeds can be lowered, to be connected upstream of the transmission. Said reduction in rotational speed brings advantages for the two electric motors, the planet gears and the prop shaft. It is thereby possible for electric motors to be loaded with only a certain maximum rotational speed. In addition, the forces acting on the needle bearings of the planet gears can be reduced in this way.

The transmission can particularly advantageously be designed in such a way that, at the switching points between two successive driving ranges, differential speeds of zero are present in each case at the clutches K1 to K4 or brakes which are to be switched. This corresponds to so-called synchronous conditions.

In addition, the transmission can particularly advantageously be designed in such a way that only two clutches K1 to K4 or brakes must be actuated during a change in the driving range, with one being engaged while the other is disengaged.

In addition, the transmission can particularly advantageously be designed such that a double power split, if present, is designed such that the extremum of the power component corresponds precisely to the installed electric power P_{el,inst}. The installed electrical power P_{el,inst} is to be understood as the ratio of the nominal power of an electric motor relative to the nominal power of the primary driving internal combustion engine.

The transmission can also particularly advantageously be designed such that the power component at the synchronous points between the two adjacent driving ranges precisely corresponds in each case to the installed electrical power P_{el,inst}.

Further advantages of the invention can be gathered from the further patent claims, the description and the drawing.

The invention is explained in the following on the basis of a plurality of exemplary embodiments.

In the drawing:

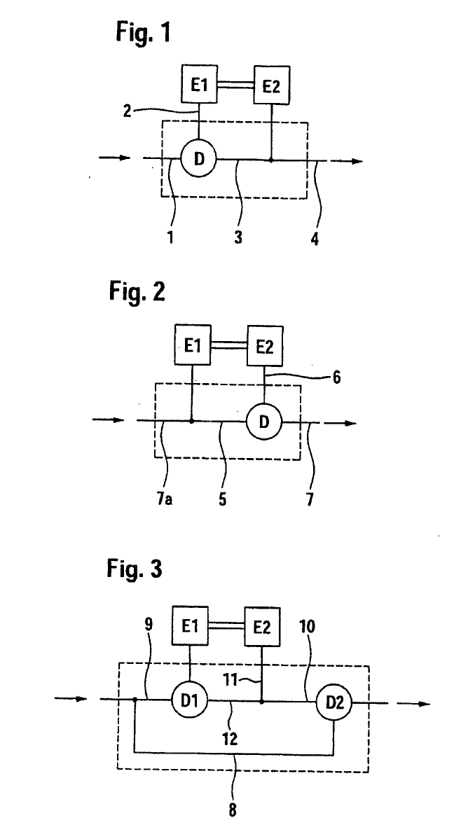

FIG. 1 schematically shows the structure of a single power split with an input-side differential,

FIG. 2 schematically shows the structure of a single power split with an output-side differential,

FIG. 3 schematically shows the structure of a double power split in a first embodiment,

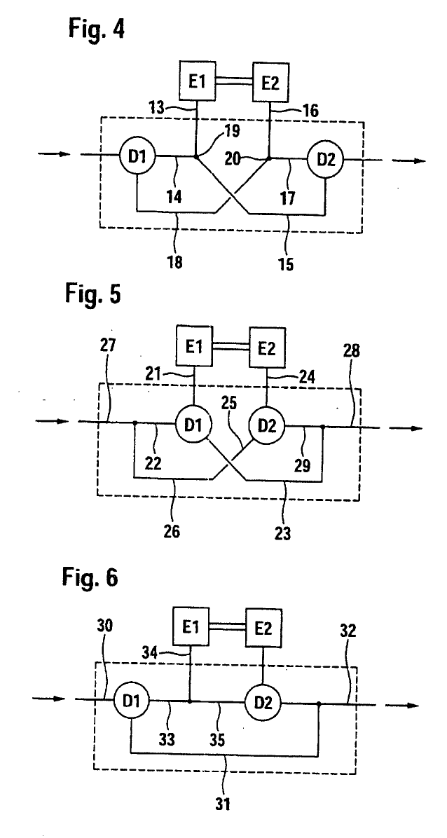

FIG. 4 schematically shows the structure of a double power split in a second embodiment,

FIG. 5 schematically shows the structure of a double power split in a third embodiment,

FIG. 6 schematically shows the structure of a double power split in a fourth embodiment,

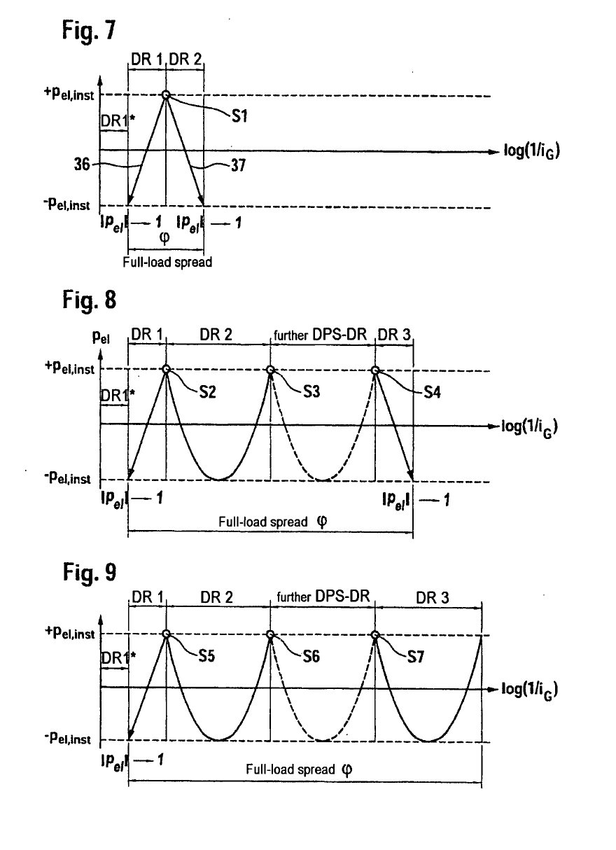

FIG. 7 schematically shows a basic transmission principle which is composed of an SPS with an input-side differential and an SPS with an output-side differential,

FIG. 8 schematically shows a basic transmission principle with is composed of an SPS with an input-side differential, at least one arbitrary DPS as per FIG. 3 to FIG. 6, and an SPS with an output-side differential,

FIG. 9 schematically shows a basic transmission principle with is composed of an SPS with an input-side differential, at least one arbitrary DPS as per FIG. 3 to FIG. 6, and a further DPS as per FIG. 3 to FIG. 6,

FIG. 10 shows a first embodiment variant of a transmission structure using the basic transmission principle as per FIG. 8 with a DPS as per FIG. 3,

FIG. 11 shows a second embodiment variant of a transmission structure using the basic transmission principle as per FIG. 8 with a DPS as per FIG. 4,

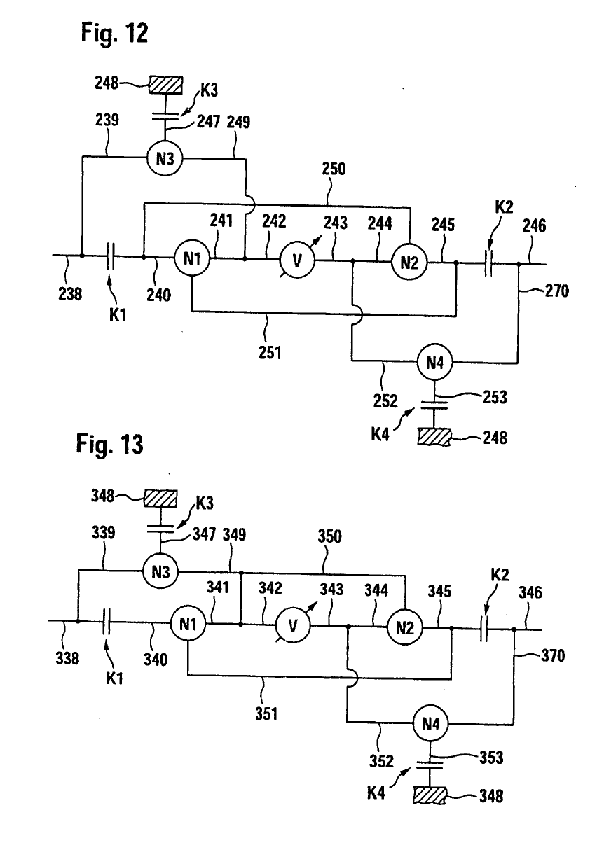

FIG. 12 shows a third embodiment variant of a transmission structure using the basic transmission principle as per FIG. 8 with a DPS as per FIG. 5,

FIG. 13 shows a fourth embodiment variant of a transmission structure using the basic transmission principle as per FIG. 8 with a DPS as per FIG. 6,

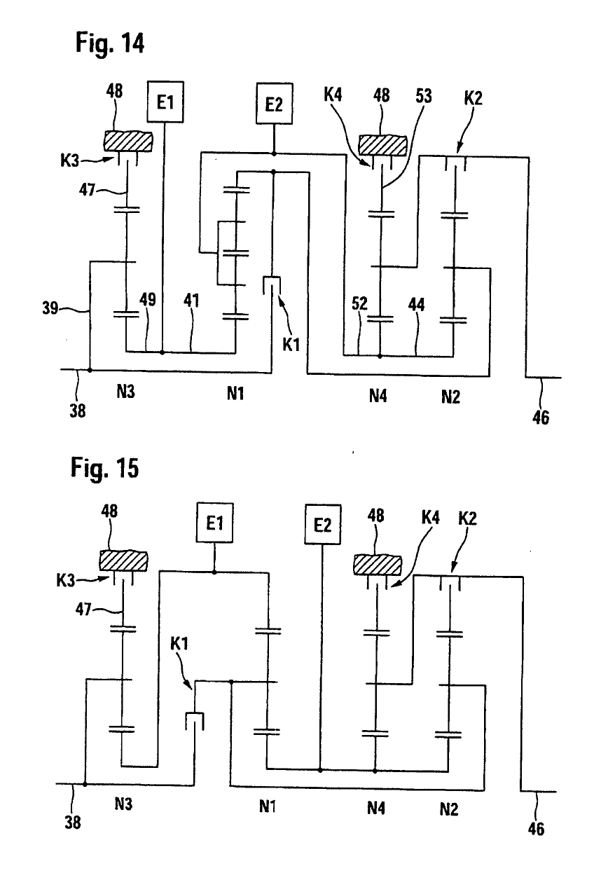

FIG. 14 shows a first embodiment variant of a transmission gear set using the basic transmission principle as per FIG. 8,

FIG. 15 shows a second embodiment variant of a transmission gear set using the basic transmission principle as per FIG. 8,

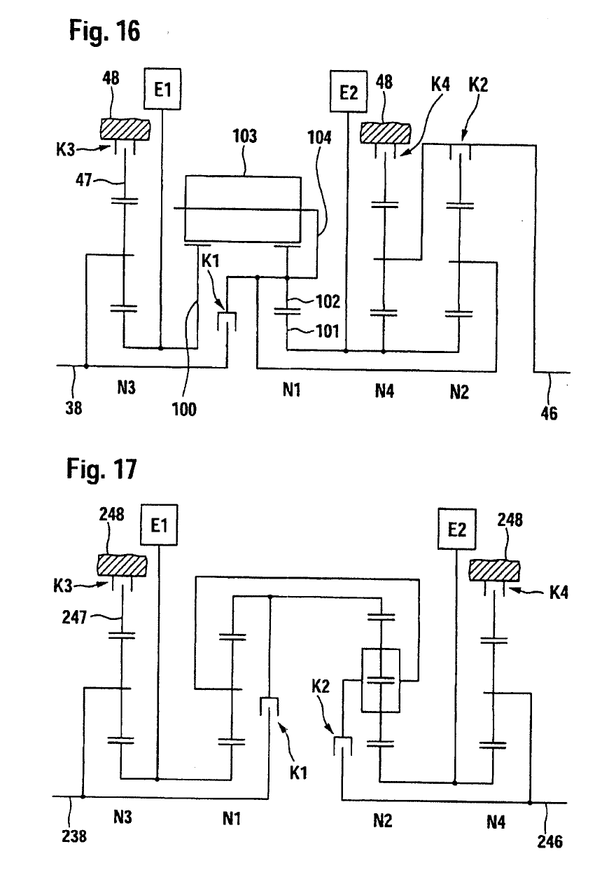

FIG. 16 shows a third embodiment variant of a transmission gear set using the basic transmission principle as per FIG. 8,

FIG. 17 shows a fourth embodiment variant of a transmission gear set using the basic transmission principle as per FIG. 8,

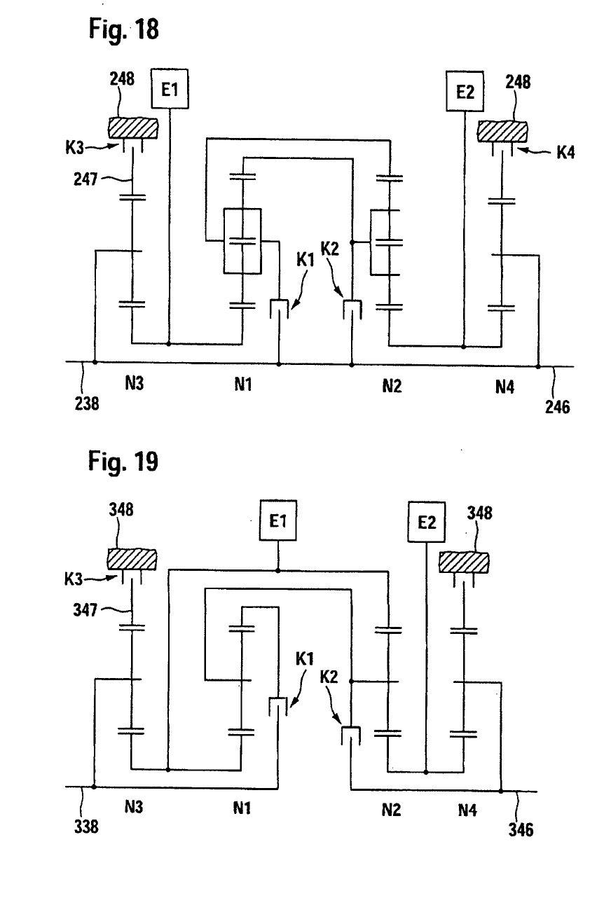

FIG. 18 shows a fifth embodiment variant of a transmission gear set using the basic transmission principle as per FIG. 8,

FIG. 19 shows a sixth embodiment variant of a transmission gear set using the basic transmission principle as per FIG. 8,

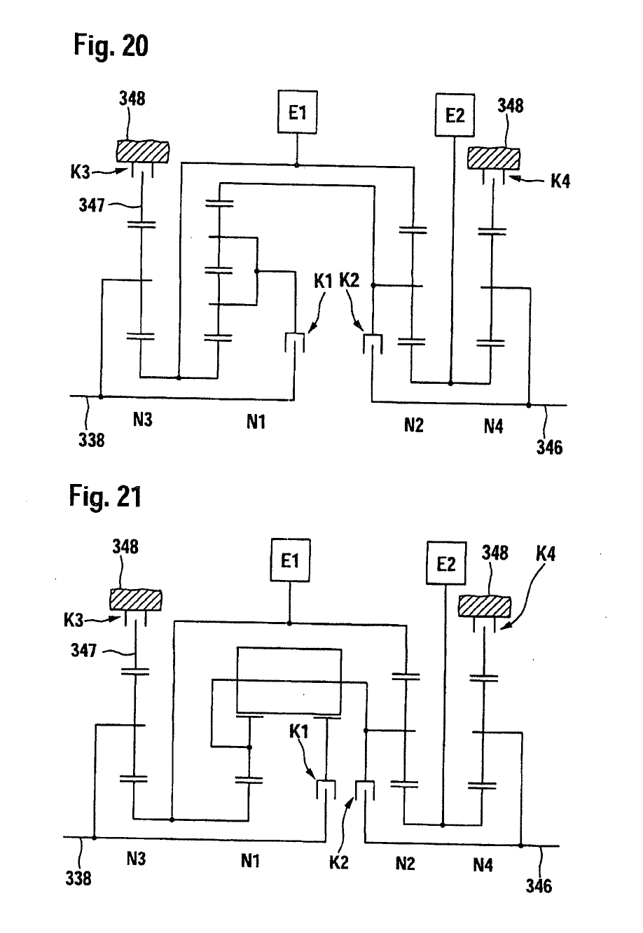

FIG. 20 shows a seventh embodiment variant of a transmission gear set using the basic transmission principle as per FIG. 8,

FIG. 21 shows an eighth embodiment variant of a transmission gear set using the basic transmission principle as per FIG. 8,

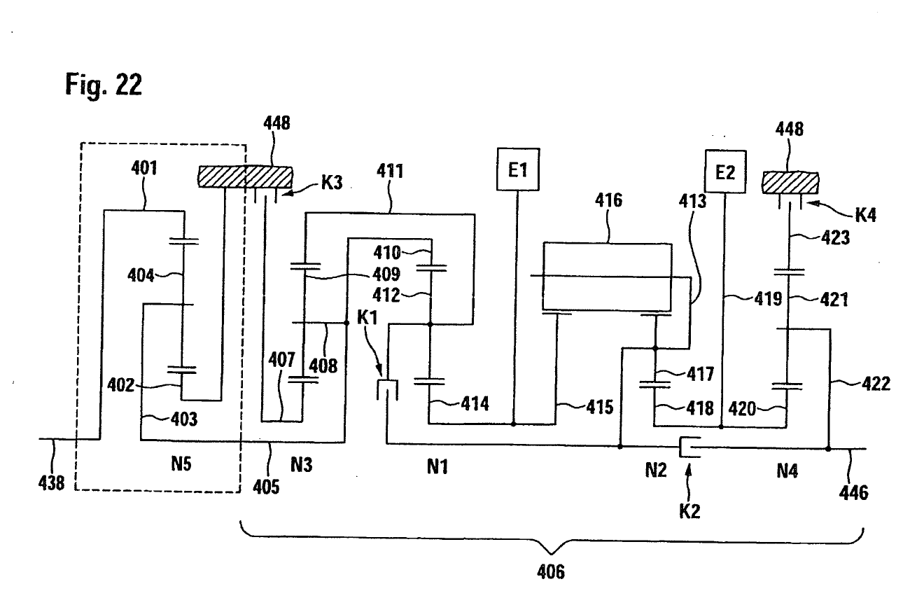

FIGS. 22 to 24 show particularly advantageous embodiments of the invention in which a reduction planetary gearing is in each case connected upstream of a core transmission for reducing the rotational speeds.

FIG. 1 schematically shows the structure of an SPS with an input-side planetary gearing or differential D. The SPS having an input-side differential D comprises, in addition to the differential D, two electric motors E1 and E2 which are electrically connected to one another, so that the respectively output and consumed power can be exchanged between said two electric motors E1 and E2. In the case of an input-side differential D of said type, the ratios of the torques in the transmission shafts 1, 2 are predefined at the front branching point. The first transmission shaft 1 is subjected to the input torque at the input rotational speed. The second transmission shaft 2 is connected to the first electric motor E1. The third transmission shaft 3 of the differential D is rotationally fixedly connected to the second electric motor E2 and the output shaft 4 of the SPS.

FIG. 2 schematically shows the structure of an SPS with an output-side differential D. The SPS having an output-side differential D likewise comprises, in addition to the differential D, the two electric motors E1 and E2 which are electrically connected to one another, so that the respectively output and consumed power can be exchanged between said two electric motors E1 and E2. In the case of an output-side differential D of said type, the ratios of the torques in the transmission shafts 6, 7 are predefined at the front branching point. The first transmission shaft 5 of the differential D is rotationally fixedly connected to the first electric motor E1 and the input shaft 7a of the SPS. The second transmission shaft 6 is connected to the second electric motor E2. The third transmission shaft 6 is subjected to the output torque at the output rotational speed.

FIG. 3 to FIG. 6 show four different embodiments of DPS. In contrast to the SPS, the action of said DPS embodiments in relation to one another is externally equivalent at the interfaces. That is to say that the same values are generated at the input and output of the DPS embodiments regardless of the structure used, though with different values—that is to say torques and rotational speeds—being generated within the transmission. Said four DPS embodiments have in common that they have two differentials D1, D2 and two electric motors E1, E2. Said two electric motors are—as is also the case in the SPS—electrically connected to one another, so that the respectively output and consumed power can be exchanged between said two electric motors.

Here, FIG. 3 schematically shows the structure of the DPS in the first embodiment. Said DPS is of fundamentally equivalent design to the SPS as per FIG. 1, but additionally having the second differential D2 arranged at the output side, whose
first transmission shaft 8 is rotationally fixedly coupled to the input shaft 9 of the DPS,
second transmission shaft 10 is rotationally fixedly coupled to the electric motor shaft 11 of E2 and the third transmission shaft 12 of the first differential D1.

FIG. 4 schematically shows the structure of the DPS in the second embodiment. The electric motor shaft 13 of E1 is rotationally fixedly coupled at a first junction 19 to the third transmission shaft 14 of the first differential D1. In addition, the electric motor shaft 13 of E1 and the third transmission shaft 14 are rotationally fixedly coupled at the first junction 19 to the first transmission shaft 15 of the second differential gearing D2. The electric motor shaft 16 of E2 is rotationally fixedly coupled at the second junction 20 to the second transmission shaft 17 of the second differential gearing D2 and the first transmission shaft 18 of the first differential D1.

The third embodiment as per FIG. 5 shows similarities to FIG. 4. For example, the two junctions 19, 20 which can be seen in FIG. 4 have been exchanged with the two differentials D1 and D2. The electric motor shaft 21 of E1 is coupled by means of the first differential D1 to the first transmission shaft 23 and the second transmission shaft 22 of the first differential D1. The electric motor shaft 24 of E2 is coupled by means of the second differential D2 to the first transmission shaft 25 of the second differential gearing D2 and the second transmission shaft 26 of the first differential D1. Said second transmission shaft 26 of the first differential D1 is rotationally fixedly coupled to the second transmission shaft 22 of the first differential D1 and the input shaft 27 of the DPS. The output shaft 28 of the DPS is rotationally fixedly coupled to the first transmission shaft 23 of the first differential D1 and the third transmission shaft 29 of the second differential 29.

The fourth embodiment as per FIG. 6 shows similarities to the first embodiment as per FIG. 3. In contrast to FIG. 3, however, said DPS is fundamentally of equivalent construction to the SPS as per FIG. 2, but additionally having the first differential D1 arranged at the input side, whose
first transmission shaft 31 is rotationally fixedly coupled to the output shaft 32 of the DPS,
second transmission shaft 30 forms the input shaft of the DPS, and
third transmission shaft 33 is rotationally fixedly coupled to the electric motor shaft 34 of E1 and the first transmission shaft 35 of the second differential D2.

In all of these structures in FIG. 1 to FIG. 6, the power in the electrical branch is clearly dependent on the current transmission ratio.

FIG. 7 to FIG. 9 schematically show basic transmission principles which are composed of an SPS with an input-side differential and a further power split adjoining the latter. Here, the SPS and the DPS have characteristic profiles for the electric power component Pₑₗ illustrated in FIG. 7 to FIG. 9. The electrical power component Pₑₗ is determined from the electrical power in relation to the input power from the internal combustion engine. Here, a distinction must be made between the input-side and output-side differentials. The power components of the SPS illustrated in FIG. 1 seek to give a transmission ratio i_{G}→∞ towards −1. Likewise, the power components of the SPS illustrated in FIG. 2 seek to give a transmission ratio i_{G}→0 towards −1. A similar situation applies in the reversed case. That is to say that the power components of the SPS illustrated in FIG. 1 seek to give a transmission ratio i_{G}→0 towards ∞. The power components of the SPS illustrated in FIG. 2 seek to give a transmission ratio i_{G}→∞ towards ∞. Accordingly, for the first driving range—that is to say for starting—the SPS as per FIG. 1 is used, beginning with a transmission ratio i_{G}→∞.

In contrast, for an overdrive driving range, the SPS as per FIG. 2 is used. Said two SPS embodiments have in common, however, that the spread range

$${φ}_{G , ges} = \frac{{i}_{G , max}}{{i}_{G , min}}$$

in
which the maximum engine power can be transmitted by the transmission is relatively small. However, the specific spread is significantly larger in the case of the DPS than in the case of the SPS. This is however associated with the disadvantage that the power component becomes infinite for both i_{G}→∞ and i_{G}→0 Accordingly, the DPS is used for mid-range driving ranges with no extreme transmission ratios.

The basic transmission principles as per FIG. 7 to FIG. 9 emerge from that stated above as particularly advantageous. Here, the basic modules of the respective drivetrain, which can be an SPS or a DPS as shown in FIG. 1 to FIG. 6, are illustrated in a first table column. In the second table column, the drivetrains illustrated to the left thereof respectively are assigned diagrams, with the electrical power Pₑₗ being plotted on the ordinate thereof against the inverse transmission ratio 1/i_{G} in logarithmic form on the abscissa. In addition, the spread Φ of the overall transmission, within which the total nominal power of the internal combustion can be transmitted by the transmission, is illustrated parallel to the abscissa. Said spread Φ of the overall transmission is also referred to as the full-load spread.

The kinematic spread of the transmission is however infinite, since starting with the transmission ratio ∞ is possible. On account of the power limitations of the electric motors, however, the transmission cannot transmit the total nominal power of the internal combustion engine between said point and the actual beginning of the first driving range, though this is also not necessary for starting.

The signs of the graphs in FIGS. 7 to 9 are dependent on the definitions of the directions of the power flows. Said signs are selected for the individual driving ranges in each case such that the graphs intersect at the synchronous points. The power flow, however, is actually reversed in the event of a change in driving range.

The schematic basic transmission principle in FIG. 7 is composed of an SPS with an input-side differential D as per FIG. 1 and an SPS with an output-side differential D as per FIG. 2. The first part 36 of the graph rises from the value −1, during starting with infinite transmission ratio i_{G}, up to the maximum possible installed electrical power +P_{el,inst}. The synchronous point S1 is ideally situated at said point of maximum possible installed electrical power +P_{el,inst}. At said synchronous point, the transmission of the drivetrain is switched from the first driving range to the second driving range, which is an overdrive driving range. The synchronous point S1 is therefore adjoined by a second part 37 of the graph in which the electrical power component falls again to the value −1 at the transmission ratio 0.

The schematic basic transmission principle in FIG. 8 differs from the basic transmission principle in FIG. 7 in that an arbitrary number of DPS are present between the two SPS. This can be either one single DPS or an n-fold number thereof. Since this therefore results in several driving ranges, there is also a plurality of synchronous points. Illustrated here are the three synchronous points S2, S3, S4 for three driving ranges. A graph extends both between S2 and S3 and between S3 and S4, which graph falls to the negative extreme of the installed electrical power −P_{el,inst} and then rises again to S3 or S4 respectively. The spread Φ is correspondingly greater than in the schematic basic transmission principle as per FIG. 7.

The schematic basic transmission principle in FIG. 9 is a refinement of the schematic basic transmission principle as per FIG. 8. In contrast to the two previous basic transmission principles, the final basic transmission module is not an SPS but rather a DPS. The full-load spread Φ is correspondingly larger than in the schematic basic transmission principle as per FIG. 8.

FIG. 10 to FIG. 13 show four embodiment variants of the particularly advantageous basic transmission principle as per FIG. 8. Said four variants use in each case one of the DPS embodiments illustrated in FIG. 3 to FIG. 6. Here, out of the theoretical n possible driving ranges, each of the four embodiment variants has three driving ranges. The number of three driving ranges here constitutes an optimum between efficiency, economy, weight and costs. The two previously mentioned electric motors E1, E2 are illustrated in a simplified manner as an electric variator V. Here, the variator V has one input shaft and one output shaft. The physical design of said variator V in the form of gear sets is illustrated in physical form again in FIG. 14 to FIG. 21. A plurality of embodiment variants which are not illustrated in any more detail can also be produced in addition to the four embodiment variants in FIG. 10 to FIG. 13.

Here, FIG. 10 shows, in the first embodiment variant, the transmission structure using the basic transmission principle as per FIG. 8 with a DPS as per FIG. 3.

An input shaft 38 which is driven by the internal combustion engine is at one side rotationally fixedly connected to the first transmission shaft 39 of a third planetary gearing N3. At the other side, the driven input shaft 38 is rotationally fixedly connected to a first clutch half of a clutch K1. The second clutch half of the clutch K1 is rotationally fixedly connected to a first transmission shaft 40 of a first planetary gearing N1. A second transmission shaft 41 of said first planetary gearing N1 is rotationally fixedly connected to an input shaft 42 of the variator V. The output shaft 43 of the variator V is rotationally fixedly connected to a first transmission shaft 44 of a second planetary gearing N2. A third transmission shaft 45 of said planetary gearing N2 is rotationally fixedly connected to a first clutch half of a second clutch K2. The second clutch half of said second clutch K2 is connected to the output shaft 46 of the transmission.

A second transmission shaft 47 of said third planetary gearing N3 is connected to a first clutch half of a third clutch K3, whereas a second clutch half of said third clutch K3 is connected to a transmission housing 48 of the transmission. The third clutch K3 is therefore a brake, so that the second transmission shaft 47 of the third planetary gearing N3 can be braked against the transmission housing 48. A third transmission shaft 49 of said third planetary gearing N3 is rotationally fixedly connected to the second transmission shaft 41 of the first planetary gearing N1 and the input shaft 42 of the variator V.

The second clutch half of the first clutch K1 and the first transmission shaft 40 of the first planetary gearing N1 is rotationally fixedly connected to a second transmission shaft 50 of the second planetary gearing N2.

A third transmission shaft 51 of the first planetary gearing N1 is rotationally fixedly connected to
the output shaft 43 of the variator V
the first transmission shaft 44 of the second planetary gearing N2 and
a first transmission shaft 52 of a fourth planetary gearing N4.

A third transmission shaft 53 of said fourth planetary gearing N4 is rotationally fixedly connected to a first clutch half of a fourth clutch K4, whereas a second clutch half of said fourth clutch K4 is connected to the transmission housing 48 of the transmission. The fourth clutch K4 is therefore a brake, so that the second transmission shaft 53 of the fourth planetary gearing N4 can be braked against the transmission housing 48.

A second transmission shaft 70 of said fourth planetary gearing N4 is rotationally fixedly connected to the output shaft 46 of the transmission.

FIGS. 14 to 16 show possible gear sets of said first embodiment variant of the transmission structure according to FIG. 10. FIGS. 14 to 16 are provided here with the same reference symbols as FIG. 10, so that said components are discussed only so far as to say that they represent a physical embodiment in relation to the schematic transmission structure of FIG. 10. Here, the four planetary gearings N1, N2, N3, N4 are provided in gear set planes with the same reference symbols N1, N2, N3, N4. The variator V is again illustrated by means of the two electric motors E1 and E2. Here, FIG. 14 to FIG. 16 have no reference symbols corresponding to those of the input shaft and of the output shaft of said variator V, since the two electric motors E1 and E2 introduce torque into the same planetary gearing partially by means of different transmission members. The following description of the gear sets of the planetary gearings N1 to N4 is carried out from the input shaft 38 driven by the internal combustion engine to the output shaft 46. Accordingly, the gear sets of the planetary gearings N1 to N4 are listed proceeding from left to right in the drawing.

The gear sets as per FIG. 14 are arranged in succession as follows:

N3: The third planetary gearing N3 has a sun gear, planet gears and a ring gear. The sun gear is rotationally fixedly connected to the electric motor shaft of E1 and to a sun gear of the subsequent first planetary gearing N1. A planet carrier of the planet gears is rotationally fixedly connected to the input shaft 38. The ring gear of the third planetary gearing N3 can be coupled by means of the transmission shaft 47 and the clutch K3 to the transmission housing 48.

N1: The first planetary gearing N1 is embodied as a double planetary gearing. A double planet carrier is both rotationally fixedly coupled to the electric motor shaft of E2 and rotationally fixedly connected to the two sun gears of the two other planetary gearings N4 and N2. The ring gear of the first planetary gearing N1 can be rotationally fixedly coupled by means of the clutch K1 to the input shaft 38. Said ring gear is also rotationally fixedly connected to the planet carrier of the second planetary gearing N2.

N4: The fourth planetary gearing comprises a ring gear, planet gears and said sun gear. The ring gear can be coupled by means of the clutch K4 to the transmission housing 48. A planet carrier of the planet gears can be rotationally fixedly coupled by means of a second clutch K2 to the ring gear of the second planetary gearing N2. Said planet carrier is also rotationally fixedly connected to the output shaft 46 of the transmission.

The gear sets as per FIG. 15 are arranged in succession as follows:

N3: The third planetary gearing N3 has a sun gear, planet gears and a ring gear. The sun gear is rotationally fixedly connected to the electric motor shaft of E1 and to a ring gear of the subsequent first planetary gearing N1. A planet carrier of the planet gears is rotationally fixedly connected to the input shaft 38. The ring gear of the third planetary gearing N3 can be coupled by means of the transmission shaft 47 and the clutch K3 to the transmission housing 48.

N1: The first planetary gearing N1 comprises said ring gear, planet gears and a sun gear. A planet carrier of the planet gears can on the one hand be coupled by means of a first clutch K1 to the input shaft 38 and is on the other hand rotationally fixedly connected to a planet carrier of the second planetary gearing N2. The sun gear of the first planetary gearing N1 is rotationally fixedly connected to
the electric motor shaft of E2,
the sun gear of the fourth planetary gearing N4 and
the sun gear of the second planetary gearing N2.

N4: The fourth planetary gearing N4 comprises a ring gear, planet gears and said sun gear. The ring gear can be coupled by means of the clutch K4 to the transmission housing 48. A planet carrier of the planet gears can be rotationally fixedly coupled by means of a second clutch K2 to the ring gear of the second planetary gearing N2. Said planet carrier is also rotationally fixedly connected to the output shaft 46 of the transmission.

The gear sets as per FIG. 16 are arranged in succession as follows:

N3: The third planetary gearing N3 has a sun gear, planet gears and a ring gear. The sun gear is rotationally fixedly connected to the electric motor shaft of E1 and to a first sun gear 100 of the axially subsequent first planetary gearing N1. A planet carrier of the planet gears is rotationally fixedly connected to the input shaft 38. The ring gear of the third planetary gearing N3 can be coupled by means of the transmission shaft 47 and the clutch K3 to the transmission housing 48.

N1: The first planetary gearing N1 is designed without an internal gear and comprises
said first sun gear 100,
a further sun gear 101 arranged axially behind the latter,
axially short planet gears 102 which mesh with the further sun gear 101 and axially long planet gears 103 which mesh at one side with said first sun gear 100 and at the other side with the axially short planet gears 102 and form a double planet by means of a double planet carrier 104.

Said double planet carrier 104 can be rotationally fixedly coupled by means of a first clutch K1 to the input shaft 38. In addition, said double planet carrier 104 is rotationally fixedly coupled to a planet carrier of the second planetary gearing N2. The further sun gear 101 of the first planetary gearing N1 is rotationally fixedly connected to
the electric motor shaft of E2,
the sun gear of the fourth planetary gearing N4 and
the sun gear of the second planetary gearing N2.

N4: The fourth planetary gearing N4 comprises a ring gear, planet gears and said sun gear. The ring gear can be coupled by means of the clutch K4 to the transmission housing 48. A planet carrier of the planet gears can be rotationally fixedly coupled by means of a second clutch K2 to the ring gear of the second planetary gearing N2. Said planet carrier is also rotationally fixedly connected to the output shaft 46 of the transmission.

FIG. 11 shows, in the second embodiment variant, the transmission structure using the basic transmission principle as per FIG. 8 with a DPS as per FIG. 4.

An input shaft 138 which is driven by the internal combustion engine is at one side rotationally fixedly connected to the first transmission shaft 139 of a third planetary gearing N3. At the other side, the driven input shaft 138 is rotationally fixedly connected to a first clutch half of a clutch K1. The second clutch half of the clutch K1 is rotationally fixedly connected to a first transmission shaft 140 of a first planetary gearing N1. A second transmission shaft 141 of said first planetary gearing N1 is rotationally fixedly connected to an input shaft 142 of the variator V. The output shaft 143 of the variator V is rotationally fixedly connected to a first transmission shaft 144 of a second planetary gearing N2. A third transmission shaft 145 of said planetary gearing N2 is rotationally fixedly connected to a first clutch half of a second clutch K2. The second clutch half of said second clutch K2 is connected to the output shaft 146 of the transmission.

A second transmission shaft 147 of said third planetary gearing N3 is connected to a first clutch half of a third clutch K3, whereas a second clutch half of said third clutch K3 is connected to a transmission housing 148 of the transmission. The third clutch K3 is therefore a brake, so that the second transmission shaft 147 of the third planetary gearing N3 can be braked against the transmission housing 148. A third transmission shaft 149 of said third planetary gearing N3 is rotationally fixedly connected to the second transmission shaft 141 of the first planetary gearing N1 and the input shaft 142 of the variator V. The third transmission shaft 149 of said third planetary gearing N3 is also rotationally fixedly connected to a second transmission shaft 150 of the second planetary gearing N2.

A third transmission shaft 151 of the first planetary gearing N1 is rotationally fixedly connected to
the output shaft 143 of the variator V
the first transmission shaft 144 of the second planetary gearing N2 and
a first transmission shaft 152 of a fourth planetary gearing N4.

A third transmission shaft 153 of said fourth planetary gearing N4 is rotationally fixedly connected to a first clutch half of a fourth clutch K4, whereas a second clutch half of said fourth clutch K4 is connected to the transmission housing 148 of the transmission. The fourth clutch K4 is therefore a brake, so that the second transmission shaft 153 of the fourth planetary gearing N4 can be braked against the transmission housing 148. A second transmission shaft 170 of said fourth planetary gearing N4 is rotationally fixedly connected to the output shaft 146 of the transmission.

FIG. 12 shows, in the third embodiment variant, the transmission structure using the basic transmission principle as per FIG. 8 with a DPS as per FIG. 5.

An input shaft 238 which is driven by the internal combustion engine is at one side rotationally fixedly connected to the first transmission shaft 239 of a third planetary gearing N3. At the other side, the driven input shaft 238 is rotationally fixedly connected to a first clutch half of a clutch K1. The second clutch half of the clutch K1 is rotationally fixedly connected to a first transmission shaft 240 of a first planetary gearing N1. A second transmission shaft 241 of said first planetary gearing N1 is rotationally fixedly connected to an input shaft 242 of the variator V. The output shaft 243 of the variator V is rotationally fixedly connected to a first transmission shaft 244 of a second planetary gearing N2. A third transmission shaft 245 of said planetary gearing N2 is rotationally fixedly connected to a first clutch half of a second clutch K2. The second clutch half of said second clutch K2 is connected to the output shaft 246 of the transmission.

A second transmission shaft 247 of said third planetary gearing N3 is connected to a first clutch half of a third clutch K3, whereas a second clutch half of said third clutch K3 is connected to a transmission housing 248 of the transmission. The third clutch K3 is therefore a brake, so that the second transmission shaft 247 of the third planetary gearing N3 can be braked against the transmission housing 248. A third transmission shaft 249 of said third planetary gearing N3 is rotationally fixedly connected to the second transmission shaft 241 of the first planetary gearing N1 and the input shaft 242 of the variator V.

The second clutch half of the first clutch K1 and the first transmission shaft 240 of the first planetary gearing N1 is rotationally fixedly connected to a second transmission shaft 250 of the second planetary gearing N2.

A third transmission shaft 251 of the first planetary gearing N1 is rotationally fixedly connected to the third transmission shaft 245 of the second planetary gearing N2.

A first transmission shaft 252 of a fourth planetary gearing N4 is rotationally fixedly connected to the output shaft 243 of the variator V and the first transmission shaft 244 of the second planetary gearing N2. A second transmission shaft 246 of the fourth planetary gearing N4 is rotationally fixedly connected to the output shaft 246 of the transmission.

A third transmission shaft 253 of said fourth planetary gearing N4 is rotationally fixedly connected to a first clutch half of a fourth clutch K4, whereas a second clutch half of said fourth clutch K4 is connected to the transmission housing 248 of the transmission. The fourth clutch K4 is therefore a brake, so that the second transmission shaft 253 of the fourth planetary gearing N4 can be braked against the transmission housing 248.

FIG. 17 and FIG. 18 show possible gear sets of said third embodiment variant of the transmission structure according to FIG. 12.

FIG. 17 and FIG. 18 are provided here with the same reference symbols as FIG. 12, so that said components are discussed only so far as to say that they represent a physical embodiment in relation to the schematic transmission structure of FIG. 12. Here, the four planetary gearings N1, N2, N3, N4 are provided in gear set planes with the same reference symbols N1, N2, N3, N4. The variator V is again illustrated by means of the two electric motors E1 and E2. Here, FIG. 17 and FIG. 18 have no reference symbols corresponding to those of the input shaft and of the output shaft of said variator V, since the two electric motors E1 and E2 introduce torque into the same planetary gearing partially by means of different transmission members. The following description of the gear sets of the planetary gearings N1 to N4 is carried out from the input shaft 38 driven by the internal combustion engine to the output shaft 46. Accordingly, the gear sets of the planetary gearings N1 to N4 are listed proceeding from left to right in the drawing.

The gear sets as per FIG. 17 are arranged in succession as follows:

N3: The third planetary gearing N3 has a sun gear, planet gears and a ring gear. The sun gear is rotationally fixedly connected to the electric motor shaft of E1 and to a sun gear of the subsequent first planetary gearing N1. A planet carrier of the planet gears is rotationally fixedly connected to the input shaft 238. The ring gear of the third planetary gearing N3 can be coupled by means of the transmission shaft 247 and the clutch K3 to the transmission housing 248.

N1: The first planetary gearing N1 is likewise embodied as a single planetary gearing with a ring gear, planet gears and said sun gear. The ring gear can be coupled by means of a clutch K1 to the planet carrier of the third planetary gearing N3. A planet carrier of the planet gear is rotationally fixedly connected to the planet carrier of the second planetary gearing N2.

N2: Said planet carrier of the second planetary gearing N2 carries a double planet and can be rotationally fixedly coupled by means of a second clutch K2 to a planet carrier of the fourth planetary gearing N4. The ring gear of the second planetary gearing N2 is rotationally fixedly connected to the first clutch half of the first clutch K1 and to the ring gear of the first planetary gearing. The sun gear of the second planetary gearing is rotationally fixedly connected to the second electric motor E2 and a sun gear of the fourth planetary gearing N4.

A double planet carrier is on the one hand coupled to the electric motor shaft of E2 and on the other hand is rotationally fixedly coupled to the two sun gears of the two other planetary gearings N4 and N2. The ring gear of the first planetary gearing N1 can be rotationally fixedly connected by means of the clutch K1 to the input shaft 38. Said ring gear is also rotationally fixedly connected to the planet carrier of the second planetary gearing N2.

N4: The fourth planetary gearing N4 comprises a ring gear, planet gears and said sun gear. The ring gear can be coupled by means of the clutch K4 to the transmission housing 248. Said planet carrier of the planet gears is rotationally fixedly connected to the output shaft 246 of the transmission.

The gear sets as per FIG. 18 are arranged in succession as follows:

N3: The third planetary gearing N3 has a sun gear, planet gears and a ring gear. The sun gear is rotationally fixedly connected to the electric motor shaft of E1 and to a sun gear of the subsequent first planetary gearing N1. A planet carrier of the planet gears is rotationally fixedly connected to the input shaft 238. The ring gear of the third planetary gearing N3 can be coupled by means of the transmission shaft 247 and the clutch K3 to the transmission housing 248.

N1: In contrast to the previous example, the first planetary gearing N1 is embodied as a double planetary gearing. A planet carrier of the double planet can be coupled by means of a clutch K1 to the planet carrier of the third planetary gearing N3. In addition, the planet carrier of the double planet of the first planetary gearing N1 is rotationally fixedly connected to a ring gear of the subsequent second planetary gearing N2. A ring gear of the first planetary gearing N1 is rotationally fixedly connected to a planet carrier of the second planetary gearing, which is likewise embodied as a double planetary gearing.

N2: Said planet carrier of the second planetary gearing N2 carries a double planet and can be rotationally fixedly coupled by means of a second clutch K2 to a planet carrier of the fourth planetary gearing N4. The sun gear of the second planetary gearing N2 is rotationally fixedly connected to the second electric motor E2 and a sun gear of the fourth planetary gearing N4.

N4: The fourth planetary gearing N4 comprises a ring gear, planet gears and said sun gear. The ring gear can be coupled by means of the clutch K4 to the transmission housing 248. Said planet carrier of the planet gears is rotationally fixedly connected to the output shaft 246 of the transmission.

FIG. 13 shows, in the fourth embodiment variant, the transmission structure using the basic transmission principle as per FIG. 8 with a DPS as per FIG. 6.

An input shaft 338 which is driven by the internal combustion engine is at one side rotationally fixedly connected to the first transmission shaft 339 of a third planetary gearing N3. At the other side, the driven input shaft 338 is rotationally fixedly connected to a first clutch half of a clutch K1. The second clutch half of the clutch K1 is rotationally fixedly connected to a first transmission shaft 340 of a first planetary gearing N1. A second transmission shaft 341 of said first planetary gearing N1 is rotationally fixedly connected to an input shaft 342 of the variator V. The output shaft 343 of the variator V is rotationally fixedly connected to a first transmission shaft 344 of a second planetary gearing N2. A third transmission shaft 345 of said planetary gearing N2 is rotationally fixedly connected to a first clutch half of a second clutch K2. The second clutch half of said second clutch K2 is connected to the output shaft 346 of the transmission.

A second transmission shaft 347 of said third planetary gearing N3 is connected to a first clutch half of a third clutch K3, whereas a second clutch half of said third clutch K3 is connected to a transmission housing 348 of the transmission. The third clutch K3 is therefore a brake, so that the second transmission shaft 347 of the third planetary gearing N3 can be braked against the transmission housing 348. A third transmission shaft 349 of said third planetary gearing N3 is rotationally fixedly connected to the second transmission shaft 341 of the first planetary gearing N1 and the input shaft 342 of the variator V. The third transmission shaft 349 of said third planetary gearing N3 is also rotationally fixedly connected to a second transmission shaft 350 of the second planetary gearing N2.

A third transmission shaft 351 of the first planetary gearing N1 is rotationally fixedly connected to the third transmission shaft 345 of the second planetary gearing N2.

A first transmission shaft 352 of a fourth planetary gearing N4 is rotationally fixedly connected to the output shaft 343 of the variator V and the first transmission shaft 344 of the second planetary gearing N2./ A second transmission shaft 346 of the fourth planetary gearing N4 is rotationally fixedly connected to the output shaft 346 of the transmission.

A third transmission shaft 353 of said fourth planetary gearing N4 is rotationally fixedly connected to a first clutch half of a fourth clutch K4, whereas a second clutch half of said fourth clutch K4 is connected to the transmission housing 348 of the transmission. The fourth clutch K4 is therefore a brake, so that the second transmission shaft 353 of the fourth planetary gearing N4 can be braked against the transmission housing 348.

A second transmission shaft 370 of said fourth planetary gearing N4 is rotationally fixedly connected to the output shaft 346 of the transmission.

FIG. 19 to FIG. 21 show possible gear sets of said third embodiment variant of the transmission structure according to FIG. 13.

FIG. 19 to FIG. 21 are provided here with the same reference symbols as FIG. 13, so that said components are discussed only so far as to say that they represent a physical embodiment in relation to the schematic transmission structure of FIG. 13. Here, the four planetary gearings N1, N2, N3, N4 are provided in gear set planes with the same reference symbols N1, N2, N3, N4. The variator V is again illustrated by means of the two electric motors E1 and E2. Here, FIG. 19 to FIG. 21 have no reference symbols corresponding to those of the input shaft and of the output shaft of said variator V, since the two electric motors E1 and E2 introduce torque into the same planetary gearing partially by means of different transmission members. The following description of the gear sets of the planetary gearings N1 to N4 is carried out from the input shaft 338 driven by the internal combustion engine to the output shaft 346. Accordingly, the gear sets of the planetary gearings N1 to N4 are listed proceeding from left to right in the drawing.

The gear sets as per FIG. 19 are arranged in succession as follows:

N3: The third planetary gearing N3 has a sun gear, planet gears and a ring gear. The sun gear is rotationally fixedly connected to the electric motor shaft of E1 and to a sun gear of the subsequent first planetary gearing N1. A planet carrier of the planet gears is rotationally fixedly connected to the input shaft 338. The ring gear of the third planetary gearing N3 can be coupled by means of the transmission shaft 347 and the clutch K3 to the transmission housing 348.

N1: The first planetary gearing N1 is likewise embodied as a single planetary gearing with a ring gear, planet gears and said sun gear. The ring gear can be coupled by means of a clutch K1 to the planet carrier of the third planetary gearing N3. A planet carrier of the planet gear is rotationally fixedly connected to the planet carrier of the second planetary gearing N2.

N2: Said planet carrier of the second planetary gearing N2 carries planet gears and can be rotationally fixedly coupled by means of a second clutch K2 to a planet carrier of the fourth planetary gearing N4. The ring gear of the second planetary gearing N2 is rotationally fixedly connected to the electric motor shaft of E1. The sun gear of the second planetary gearing N2 is rotationally fixedly connected to the second electric motor E2 and a sun gear of the fourth planetary gearing N4.

N4: The fourth planetary gearing N4 comprises a ring gear, planet gears and said sun gear. The ring gear can be coupled by means of the clutch K4 to the transmission housing 348. Said planet carrier of the planet gears is rotationally fixedly connected to the output shaft 346 of the transmission.

The gear sets as per FIG. 20 are arranged in succession as follows:

N3: The third planetary gearing N3 has a sun gear, planet gears and a ring gear. The sun gear is rotationally fixedly connected to the electric motor shaft of E1 and to a sun gear of the subsequent first planetary gearing N1. A planet carrier of the planet gears is rotationally fixedly connected to the input shaft 338. The ring gear of the third planetary gearing N3 can be coupled by means of the transmission shaft 347 and the clutch K3 to the transmission housing 348.

N1: In contrast to the previous example, the first planetary gearing N1 is embodied as a double planetary gearing with a ring gear, double planet gears and said sun gear. The ring gear can be coupled by means of a clutch K1 to the planet carrier of the third planetary gearing N3. The ring gear is rotationally fixedly connected to the planet carrier of the second planetary gearing N2.

N2: Said planet carrier of the second planetary gearing N2 carries planet gears and can be rotationally fixedly coupled by means of a second clutch K2 to a planet carrier of the fourth planetary gearing N4. The sun gear of the second planetary gearing N2 is rotationally fixedly connected to the second electric motor E2 and a sun gear of the fourth planetary gearing N4.

N4: The fourth planetary gearing N4 comprises a ring gear, planet gears and said sun gear. The ring gear can be coupled by means of the clutch K4 to the transmission housing 348. Said planet carrier of the planet gears is rotationally fixedly connected to the output shaft 346 of the transmission.

The gear sets as per FIG. 21 are arranged in succession as follows:

N3: The third planetary gearing N3 has a sun gear, planet gears and a ring gear. The sun gear is rotationally fixedly connected to the electric motor shaft of E1 and to a sun gear of the subsequent first planetary gearing N1. A planet carrier of the planet gears is rotationally fixedly connected to the input shaft 338. The ring gear of the third planetary gearing N3 can be coupled by means of the transmission shaft 347 and the clutch K3 to the transmission housing 348.

N1: In contrast to the previous example, the first planetary gearing N1 is embodied as a combined double planetary gearing without a ring gear. Said sun gear of the first planetary gearing N1 meshes with double planets whose radially outer planet gear is embodied as an axially long planet gear and meshes with a further sun gear. Said further sun gear can be coupled by means of a clutch K1 to the planet carrier of the third planetary gearing N3. A planet carrier of the double planet is rotationally fixedly connected to the planet carrier of the second planetary gearing N2.

N2: Said planet carrier of the second planetary gearing N2 carries planet gears and can be rotationally fixedly coupled by means of a second clutch K2 to a planet carrier of the fourth planetary gearing N4. The ring gear of the second planetary gearing N2 is rotationally fixedly connected to the electric motor shaft of E1. The sun gear of the second planetary gearing N2 is rotationally fixedly connected to the second electric motor E2 and a sun gear of the fourth planetary gearing N4.

N4: The fourth planetary gearing N4 comprises a ring gear, planet gears and said sun gear. The ring gear can be coupled by means of the clutch K4 to the transmission housing 348. Said planet carrier of the planet gears is rotationally fixedly connected to the output shaft 346 of the transmission.

FIG. 22 to FIG. 24 show particularly advantageous embodiments of the invention in which a reduction planetary gearing is in each case connected upstream of a core transmission for reducing the rotational speeds. This is associated with an increase in torque.

FIG. 22 illustrates the additional reduction planetary gearing N5 encircled by a dashed line. The reduction planetary gearing N5 comprises a ring gear 401 which is rotationally fixedly connected to the input shaft 438 of the transmission. In contrast, the sun gear 402 of the transmission is rotationally fixedly supported on the transmission housing 448. Accordingly, the drive power is transmitted, with a reduction in rotational speed, from planet gears 404 via a planet carrier 403 to an input shaft 405 of the core transmission 406.

The core transmission 406 comprises four planetary gearings N1 to N4. A third planetary gearing N3 is arranged axially as the first planetary gearing after the internal combustion engine and the core transmission gear sets.

N3: The sun gear 407 thereof can be supported relative to the transmission housing 448 by means of a clutch K3. A planet carrier 408 of the planet gears 409 is rotationally fixedly connected to the input shaft 405 of the core transmission 406. In addition, the planet carrier 408 of the planet gears 409 is rotationally fixedly connected to a ring gear 410 of the subsequent first planetary gearing N1.

N1: A planet carrier 411 of planet gears 412 of said first planetary gearing N1 is rotationally fixedly connected by means of a first clutch K1 to a planet carrier 413 of the subsequent planetary gearing N2 and a first clutch half of the clutch K2. A sun gear 414 of said first planetary gearing N1 is rotationally fixedly connected to an electric motor shaft of E1. In addition, said sun gear and the electric motor shaft of E1 is rotationally fixedly connected to a sun gear 415 of the planetary gearing N2.

N2: The planetary gearing N2 comprises, in addition to said sun gear 415 and said planet carrier 413 which carries planet gears 416, further planet gears 417 and a further sun gear 418. Here, the planet gears 416 and the further planet gears 417 belong to a double planet. The radially outer planet gears 416 of the double planet mesh with a sun gear 415, whereas the radially inner planet gears 417 mesh with the further sun gear 418. Said sun gear 418 is rotationally fixedly connected to the electric motor shaft 419 of the second electric motor E2, which electric motor shaft 419 is also connected to a sun gear 420 of the axially subsequent planetary gearing N4.

N4: The sun gear 420 thereof meshes with planets 421, whose planet carrier 422 is rotationally fixedly connected to the output shaft 446 of the transmission. The ring gear 423 can be rotationally fixedly coupled by means of a clutch K4 to the transmission housing 448.

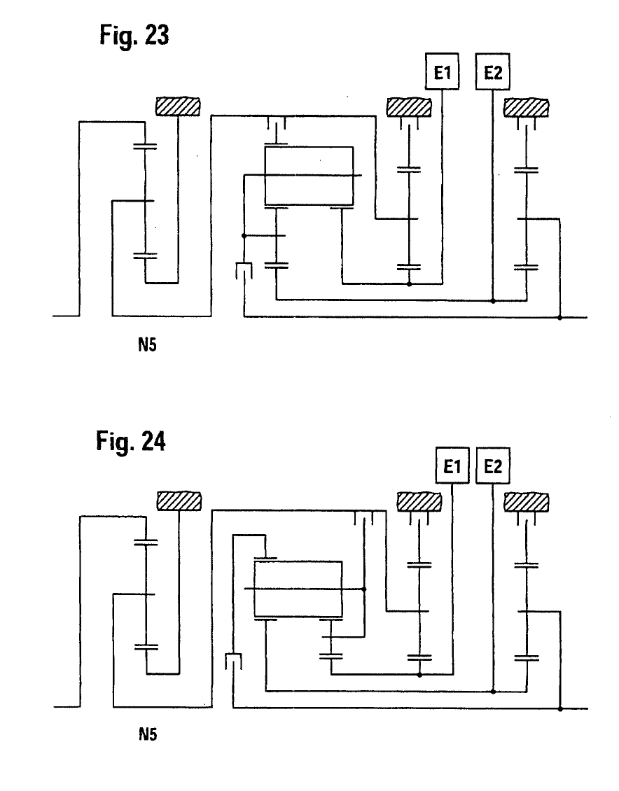

FIG. 22 and FIG. 23 show further gear sets with a reduction planetary gearing N5 connected upstream thereof.

In further embodiments of the invention, the reduction planetary gearing can advantageously be connected upstream of each of FIG. 14 to FIG. 21.

The transmissions in all the embodiments as per FIG. 14 to FIG. 24 and sub-combinations of said embodiments can be designed in such a way that, at the switching points between two successive driving ranges, differential speeds of zero are present in each case at the clutches K1 to K4 or brakes which are to be switched. This corresponds to so-called synchronous conditions.

In addition, the transmissions in all the embodiments as per FIG. 14 to FIG. 24 can be designed in such a way that only two clutches K1 to K4 or brakes must be actuated during a change in the driving range, with one being engaged while the other is disengaged.

The transmissions in all the embodiments as per FIG. 14 to FIG. 24 and sub-combinations of said embodiments can be designed such that a DPS, if present, is designed such that the extremum of the power component corresponds precisely to the installed electric power P_{el,inst}.

The transmissions in all the embodiments as per FIG. 14 to FIG. 24 and sub-combinations of said embodiments can in particular be designed such that the power component at the synchronous points between the two adjacent driving ranges precisely corresponds in each case to the installed electrical power P_{el,inst}.

The described embodiments are only exemplary embodiments. It is likewise possible to combine the described features for different embodiments. Further features, which are in particular not described, of the device parts pertaining to the invention can be gathered from the geometries of the device parts as illustrated in the drawings.

1. A power-split transmission for a hybrid vehicle having an internal combustion engine, wherein the transmission has two electric motors (E1, E2) and a plurality of planetary gearings (N1, N2, N3, N4), and wherein for starting in a first driving range, a single power-split structure is provided at the input side, which structure is adjoined in a further driving range by a further power split for an overdrive.

2. The power-split transmission as claimed in patent claim 1, wherein
at least one additional driving range is situated between the first driving range for starting and the further driving range for the overdrive.

3. The power-split transmission as claimed in patent claim 1, wherein
the power split for the overdrive is formed by means of a double power split.

4. The power-split transmission as claimed in claim 1,
an input transmission element of a core transmission of the transmission is a planet carrier (39, 408).

5. The power-split transmission as claimed in claim 1, wherein
the transmission is composed of a core transmission (406) and, connected upstream of the latter in the force flow, a reduction transmission (N5).

6. The power-split transmission as claimed in patent claim 5, wherein
the reduction transmission is a planetary gearing.

7. The power-split transmission as claimed in patent claim 6, wherein
the reduction transmission comprises
a sun gear (402) which is supported relative to a transmission housing (448),
an internal gear (401) which is driven by the internal combustion engine, and
a planet carrier (403) which supports planet gears (404), with the planet carrier (403) being rotationally fixedly connected to an input shaft (405) of the core transmission.

8. The power-split transmission as claimed in claim 1, wherein
the two electric motors (E1, E2) form a continuously variable variator (V).

9. The power-split transmission as claimed in patent claim 8, wherein
an input shaft (38) which is driven by the internal combustion engine is at one side rotationally fixedly connected to a first transmission shaft (39) of a third planetary gearing (N3) and at the other side is rotationally fixedly connected to a first clutch half of a first clutch (K1), wherein a second clutch half of said first clutch (K1) is rotationally fixedly connected to a first transmission shaft (40) of a first planetary gearing (N1), and a second transmission shaft (41) of said first planetary gearing (N1) is rotationally fixedly connected to an input shaft (42) of the variator (V), wherein the output shaft (43) of the variator (V) is rotationally fixedly connected to a first transmission shaft (44) of a second planetary gearing (N2), wherein a third transmission shaft (45) of said planetary gearing (N2) is rotationally fixedly connected to a first clutch half of a second clutch (K2), whose second clutch half is connected to the output shaft (46) of the transmission, wherein a second transmission shaft (47) of said third planetary gearing (N3) is connected to a first clutch half of a third clutch (K3), whereas a second clutch half of said third clutch (K3) is connected to a transmission housing (48) of the transmission, so that the third clutch (K3) forms a brake, by means of which the second transmission shaft (47) of the third planetary gearing (N3) can be braked against the transmission housing (48), wherein a third transmission shaft (49) of said third planetary gearing (N3) is rotationally fixedly connected to the second transmission shaft (41) of the first planetary gearing (N1) and the input shaft (42) of the variator (V), wherein the second clutch half of the first clutch (K1) and the first transmission shaft (40) of the first planetary gearing (N1) is rotationally fixedly connected to a second transmission shaft (50) of the second planetary gearing (N2), and a third transmission shaft (51) of the first planetary gearing (N1) is rotationally fixedly connected to
the output shaft (43) of the variator (V),
the first transmission shaft (44) of the second planetary gearing (N2) and
a first transmission shaft (52) of a fourth planetary gearing (N4)
and a third transmission shaft (53) of said fourth planetary gearing (N4) is rotationally fixedly connected to a first clutch half of a fourth clutch (K4), whereas a second clutch half of said fourth clutch (K4) is connected to the transmission housing (48) of the transmission, so that the fourth clutch (K4) forms a brake, by means of which the second transmission shaft (53) of the fourth planetary gearing (N4) can be braked against the transmission housing (48), wherein a second transmission shaft (70) of said fourth planetary gearing (N4) is rotationally fixedly connected to the output shaft (46) of the transmission.

10. The power-split transmission as claimed in patent claim 8, wherein
an input shaft (138) which is driven by the internal combustion engine is at one side rotationally fixedly connected to the first transmission shaft (139) of a third planetary gearing (N3) and at the other side is rotationally fixedly connected to a first clutch half of a first clutch (K1), wherein the second clutch half of the clutch (K1) is rotationally fixedly connected to a first transmission shaft (140) of a first planetary gearing (N1), wherein a second transmission shaft (141) of said first planetary gearing (N1) is rotationally fixedly connected to an input shaft (142) of the variator (V), wherein the output shaft (143) of the variator (V) is rotationally fixedly connected to a first transmission shaft (144) of a second planetary gearing (N2), wherein a third transmission shaft (145) of said planetary gearing (N2) is rotationally fixedly connected to a first clutch half of a second clutch (K2), wherein the second clutch half of said second clutch (K2) is connected to the output shaft (146) of the transmission, wherein a second transmission shaft (147) of said third planetary gearing (N3) is connected to a first clutch half of a third clutch (K3), whereas a second clutch half of said third clutch (K3) is connected to a transmission housing (148) of the transmission, so that the third clutch (K3) forms a brake, so that the second transmission shaft (147) of the third planetary gearing (N3) can be braked against the transmission housing (148), wherein a third transmission shaft (149) of said third planetary gearing (N3) is rotationally fixedly connected to the second transmission shaft (141) of the first planetary gearing (N1) and the input shaft (142) of the variator (V), wherein the third transmission shaft (149) of said third planetary gearing (N3) is also rotationally fixedly connected to a second transmission shaft (150) of the second planetary gearing (N2), wherein a third transmission shaft (151) of the first planetary gearing (N1) is rotationally fixedly connected to
the output shaft (143) of the variator (V),
the first transmission shaft (144) of the second planetary gearing (N2) and
a first transmission shaft (152) of a fourth planetary gearing (N4)
and a third transmission shaft (153) of said fourth planetary gearing (N4) is rotationally fixedly connected to a first clutch half of a fourth clutch (K4), whereas a second clutch half of said fourth clutch (K4) is connected to the transmission housing (148) of the transmission, so that the fourth clutch (K4) forms a brake, so that the second transmission shaft (153) of the fourth planetary gearing (N4) can be braked against the transmission housing (148), wherein a second transmission shaft (170) of said fourth planetary gearing (N4) is rotationally fixedly connected to the output shaft (146) of the transmission.

11. The power-split transmission as claimed in patent claim 8, wherein
an input shaft (238) which is driven by the internal combustion engine is at one side rotationally fixedly connected to the first transmission shaft (239) of a third planetary gearing (N3) and at the other side is rotationally fixedly connected to a first clutch half of a first clutch (K1), wherein the second clutch half of the clutch (K1) is rotationally fixedly connected to a first transmission shaft (240) of a first planetary gearing (N1), wherein a second transmission shaft (241) of said first planetary gearing (N1) is rotationally fixedly connected to an input shaft (242) of the variator (V), wherein the output shaft (243) of the variator (V) is rotationally fixedly connected to a first transmission shaft (244) of a second planetary gearing (N2), wherein a third transmission shaft (245) of said planetary gearing (N2) is rotationally fixedly connected to a first clutch half of a second clutch (K2), wherein the second clutch half of said second clutch (K2) is connected to the output shaft (246) of the transmission, wherein a second transmission shaft (247) of said third planetary gearing (N3) is connected to a first clutch half of a third clutch (K3), whereas a second clutch half of said third clutch (K3) is connected to a transmission housing (248) of the transmission, so that the third clutch (K3) forms a brake, so that the second transmission shaft (247) of the third planetary gearing (N3) can be braked against the transmission housing (248), wherein a third transmission shaft (249) of said third planetary gearing (N3) is rotationally fixedly connected to the second transmission shaft (241) of the first planetary gearing (N1) and the input shaft (242) of the variator (V), wherein the second clutch half of the first clutch (K1) and the first transmission shaft (240) of the first planetary gearing (N1) is rotationally fixedly connected to a second transmission shaft (250) of the second planetary gearing (N2), wherein a third transmission shaft (251) of the first planetary gearing (N1) is rotationally fixedly connected to the third transmission shaft (245) of the second planetary gearing (N2), wherein a first transmission shaft (252) of a fourth planetary gearing (N4) is rotationally fixedly connected to the output shaft (243) of the variator (V) and the first transmission shaft (244) of the second planetary gearing (N2), wherein a second transmission shaft (270) of the fourth planetary gearing (N4) is rotationally fixedly connected to the output shaft (246) of the transmission, wherein a third transmission shaft (253) of said fourth planetary gearing (N4) is rotationally fixedly connected to a first clutch half of a fourth clutch (K4), whereas a second clutch half of said fourth clutch (K4) is connected to the transmission housing (248) of the transmission, so that the fourth clutch (K4) forms a brake, by means of which the second transmission shaft (253) of the fourth planetary gearing (N4) can be braked against the transmission housing (248).

12. The power-split transmission as claimed in patent claim 8, wherein
an input shaft (338) which is driven by the internal combustion engine is at one side rotationally fixedly connected to the first transmission shaft (339) of a third planetary gearing (N3) and at the other side is rotationally fixedly connected to a first clutch half of a clutch (K1), wherein the second clutch half of the clutch (K1) is rotationally fixedly connected to a first transmission shaft (340) of a first planetary gearing (N1), wherein a second transmission shaft (341) of said first planetary gearing (N1) is rotationally fixedly connected to an input shaft (342) of the variator (V), wherein the output shaft (343) of the variator (V) is rotationally fixedly connected to a first transmission shaft (344) of a second planetary gearing (N2), wherein a third transmission shaft (345) of said planetary gearing (N2) is rotationally fixedly connected to a first clutch half of a second clutch (K2), wherein the second clutch half of said second clutch (K2) is connected to the output shaft (346) of the transmission, wherein a second transmission shaft (347) of said third planetary gearing (N3) is connected to a first clutch half of a third clutch (K3), whereas a second clutch half of said third clutch (K3) is connected to a transmission housing (348) of the transmission, so that the third clutch (K3) forms a brake, so that the second transmission shaft (347) of the third planetary gearing (N3) can be braked against the transmission housing (348), wherein a third transmission shaft (349) of said third planetary gearing (N3) is rotationally fixedly connected to the second transmission shaft (341) of the first planetary gearing (N1) and the input shaft (342) of the variator (V), wherein the third transmission shaft (349) of said third planetary gearing (N3) is rotationally fixedly connected to a second transmission shaft (350) of the second planetary gearing (N2), wherein a third transmission shaft (351) of the first planetary gearing (N1) is rotationally fixedly connected to the third transmission shaft (345) of the second planetary gearing (N2), wherein a first transmission shaft (352) of a fourth planetary gearing (N4) is rotationally fixedly connected to the output shaft (343) of the variator (V) and the first transmission shaft (344) of the second planetary gearing (N2), wherein a second transmission shaft (370) of the fourth planetary gearing (N4) is rotationally fixedly connected to the output shaft (346) of the transmission, wherein a third transmission shaft (353) of said fourth planetary gearing (N4) is rotationally fixedly connected to a first clutch half of a fourth clutch (K4), whereas a second clutch half of said fourth clutch (K4) is connected to the transmission housing (348) of the transmission, so that the fourth clutch (K4) forms a brake, by means of which the second transmission shaft (353) of the fourth planetary gearing (N4) can be braked against the transmission housing (348).
